(19) United States
(12) Patent Application Publication
(10) Pub. No.: US 2002/0058538 A1
(43) Pub. Date: May 16, 2002

(54) Wireless communications backpack for a portable computing device

(75) Inventors: Jud M. Gudgel, Tulsa, OK (US); Stuart K. Bond, Tulsa, OK (US); Brian S. Aldham, Tulsa, OK (US); Michael Gaut, Broken Arrow, OK (US)

Correspondence Address: Carol M. Nielsen, GARDERE WYNNE SEWELL LLP, Patent Section (H), 1601 Elm Street, Suite 3000, Dallas, TX, 75201, US

(73) Assignee: TouchStar Americas, Inc.

(21) Appl. No.: 10/008,172

(22) Filed: Nov. 13, 2001

Related U.S. Application Data
(60) Provisional application No. 60/247,195, filed on Nov. 11, 2000.

(51) Int. Cl. H04M 1/00

(52) U.S. Cl. 455/572; 455/557

(57) ABSTRACT

A wireless communications backpack comprising a housing, a portable computing device, a battery and a wireless communication device. The subject invention provides digital wireless communications over a cellular network and simultaneously provides electrical power for operation of both the computing device and the communications device.

### CROSS REFERENCE TO RELATED APPLICATION

This application is based on Provisional Application Serial No. 60/247,195 filed Nov. 11, 2000.

### FIELD OF INVENTION

The present invention relates to a wireless communications backpack for a portable computing device. More particularly, but not by way of limitation, the present invention relates to an attachment for a hand held computer (i.e., personal digital assistant (PDA) or the like) or a portable peripheral device, such as a printer, which provides battery power for the computing device and includes a radio transceiver for both digital and analog communications of data and voice, over an existing wireless network.

### BACKGROUND OF THE INVENTION

As computing in general has evolved, there has been an ever increasing reliance on inter-computer communication. Typically, such communication takes place over a local area network (LAN), a wide area network (WAN), the Internet, or some equivalent wired network.

Over the same period, the size and the electrical power requirements for a given degree of computing power have been ever decreasing, vastly improving the viability of portable computers and related peripheral devices.

Naturally there has developed a need for portable computing devices to communicate with other computing devices and to retain the portability of such portable devices while communicating. A number of solutions have been developed to fill this need, although thus far no solution universally fills the needs.

For example, many portable computing devices include a wireless infrared interface for communicating with another computer or a printer. This interface is limited to nearby devices which are within a line-of-sight.

In another example, wireless devices are available for use with local area networks. These devices allow a portable computing device to communicate through a local area network, typically via radio frequencies. Such devices often connect through a card slot on the portable device and characteristically are limited to short range communication, typically a few hundred feet. Depending on the portable device and the particular wireless device, the combination of these is often clumsy resulting in decreased portability of the device.

For dial-up remote connection to a network, a number of cellular modems have been developed. For the purposes of this application, the term “cellular” is used to describe any multiple access wireless network and not limited to any particular system, by way of example and not limitation, whether the wireless network is digital or analog, regardless of frequency of operation, regardless of bandwidth, whether intended for voice or digital, whether connected to the conventional switched telephone network or not, regardless of the access scheme (i.e., frequency division multiple access, time division multiple access, code division multiple access, or other like access scheme), and regardless of the name under which the network is marketed.

Generally, cellular modems connect to a portable computer through a PCMCIA bus. These modems then connect to a cellular phone through a cable. Recently, some cellular phone manufacturers have offered phones which provide a direct connection to a computer serial port, eliminating the need for a separate modem, however, these phones still require a cable for interconnection with the computer. Unfortunately, having multiple units tethered to one-another is not conducive to portable operation. In addition, attempting to interface a computer from one manufacturer to the modem of a second manufacturer for connection to a cellular phone from yet a third manufacturer for use on a cellular network operated by still yet a fourth party, poses an insurmountable challenge for all but the most astute users.

It is thus an object of the present invention to provide a wireless communications backpack for a portable computing device which provides both digital wireless communications over a cellular network and which simultaneously provides electrical power for operation of both the computing device and the communications device.

It is a further object of the present invention to provide a wireless communications backpack for a portable computing device which provides voice wireless communication over a cellular network and which simultaneously provides electrical power for operation of both the computing device and the communication device.

It is still a further object of the present invention to provide a wireless communications backpack for a portable computing device which replaces the battery of the battery of the portable device such that, with the backpack attached, the portable computing device includes self contained wireless communication.

### SUMMARY OF THE INVENTION

The present invention provides a wireless communications backpack for a portable computing device which resolves the problems and satisfies the needs identified above. The wireless communications backpack comprises: a housing for mounting the backpack to a portable computing device; a battery and associated circuitry to provide voltages suitable for powering the portable computing device as well as the backpack; and a wireless communications device.

In one embodiment, the backpack provides both audio wireless communication and digital wireless communication such that when the backpack is attached to a portable computing device, the operator is provided digital communication for communicating with other computers or peripherals and the operator is provided with a device for speech communication.

In another embodiment, a backpack is provided for attachment to a peripheral device, such as a printer, to provides wireless communication between the peripheral device and a network. Output may be directed to, or input received from, the peripheral device by any computing device attached to the network.

In yet another embodiment, the backpack includes a battery and associated circuitry to supply power to both the portable computing device and the wireless communication device.

Further objects, features, and advantages of the present invention will be apparent to those skilled in the art upon examining the accompanying drawings and upon reading the following description of the preferred embodiments.

### BRIEF DESCRIPTION OF THE DRAWINGS

FIG. 1 provides a perspective view of a portable computing device whereon is incorporated an inventive wireless communications backpack.

FIG. 2 provides a perspective from the back of a portable computing device computer whereon is incorporated an inventive wireless communications backpack.

FIG. 3 provides a front view of a battery as commonly supplied with a portable computing device.

FIG. 4 provides a rear view of a portable computing device showing the interface for either a battery or an inventive backpack.

FIG. 5 provides a rear view a front view of a wireless transceiver as incorporated in the inventive backpack.

FIG. 6 provides a perspective back view of a backpack for use on a portable peripheral device.

FIG. 7 provides a block diagram of the circuitry employed in a single transceiver embodiment of the inventive backpack.

FIG. 8 provides a block diagram of the circuitry employed in a dual transceiver embodiment of the inventive backpack.

### DESCRIPTION OF THE PREFERRED EMBODIMENTS

Before explaining the present invention in detail, it is important to understand that the invention is not limited in its application to the details of the construction illustrated and the steps described herein. The invention is capable of other embodiments and of being practiced or carried out in a variety of ways, it is to be understood that the phraseology and terminology employed herein is for the purpose of description and not of limitation.

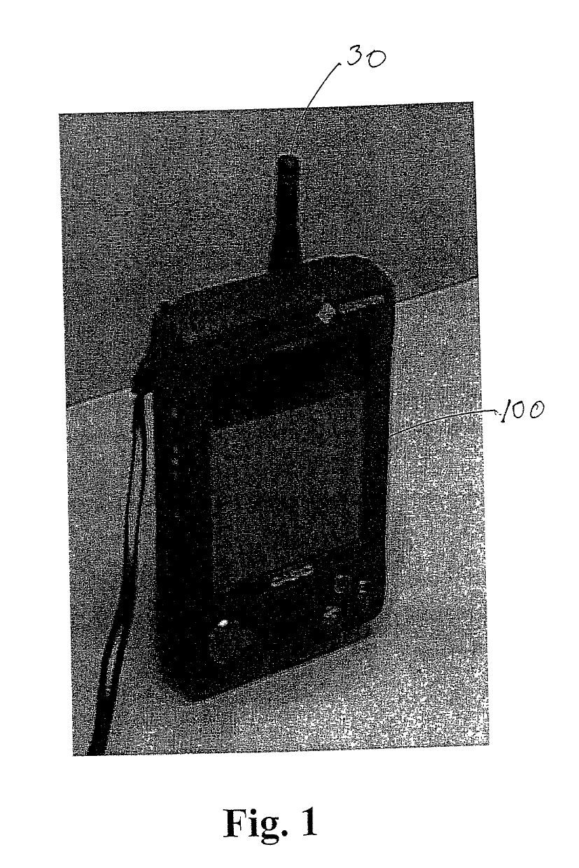

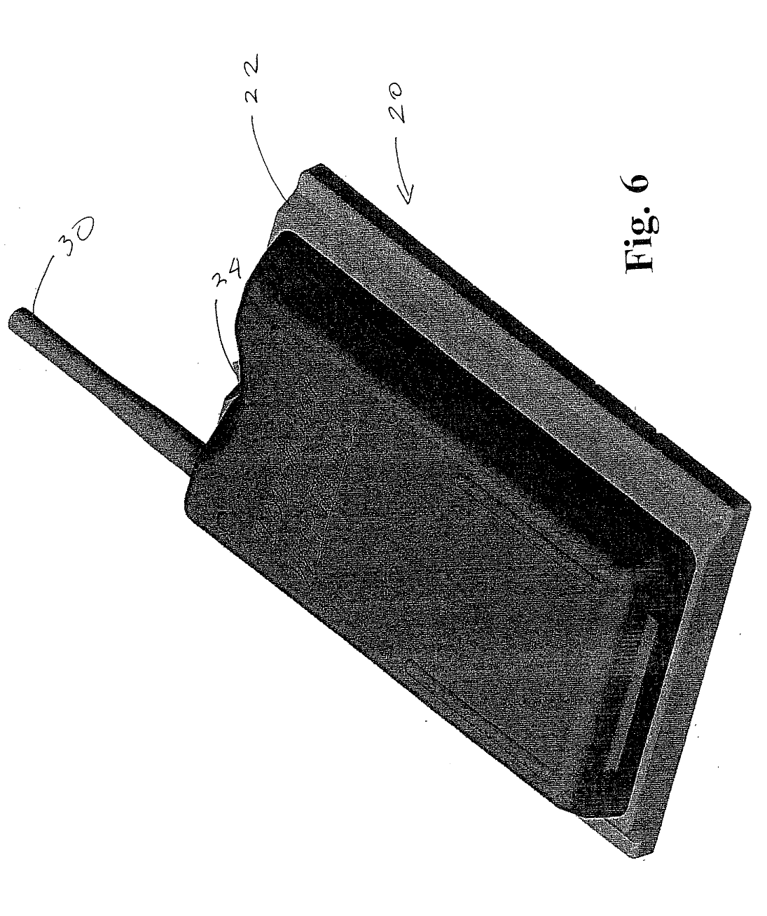

Referring now to the drawings, wherein like reference numerals indicate the same parts throughout the several views, a preferred embodiment of the inventive wireless communications backpack 20 is shown in FIG. 6. Preferably, backpack 20 comprises a housing 22 which includes flange 24 for attaching the backpack to a portable computing device 100 (FIG. 1), and an antenna 30 for transmitting and receiving radio frequency signals to and from another transceiver.

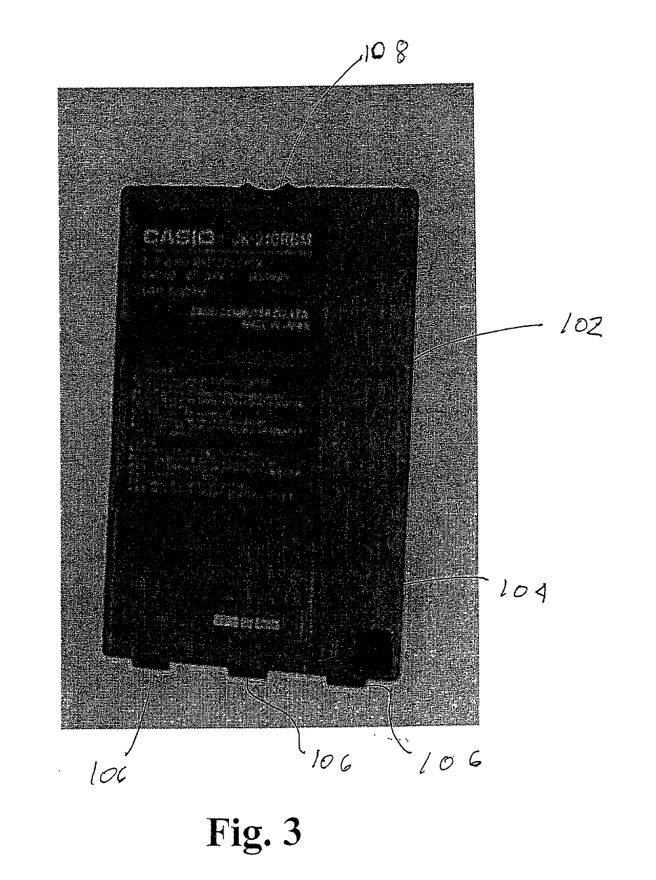

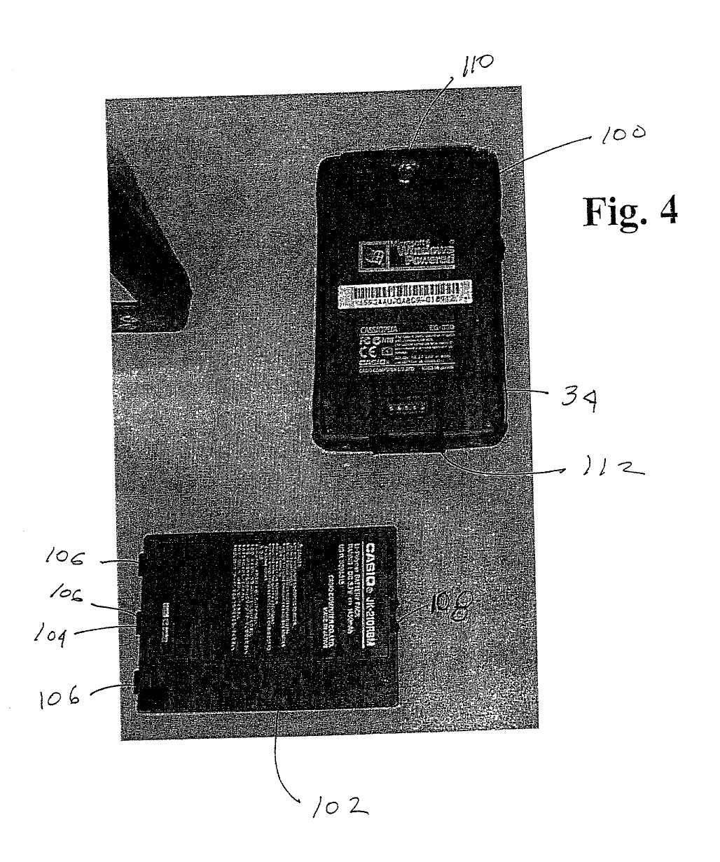

Typically, as shown in FIGS. 3 and 4, a portable computing device 100 will be provided by its manufacturer with a battery 102. Battery 102 provides electrical power for operation of the portable computing device 100 through connector 104 which mates with contacts 34. Battery 102 is removably attached to the computing device 100 with a plurality of tabs 106 and flange 108 secured by latch 110. In addition, computing device 100 provides an interface for input and output at connector 112. As will be understood by those skilled in the art, the ability to input and output data is essential to the operation of such computing devices.

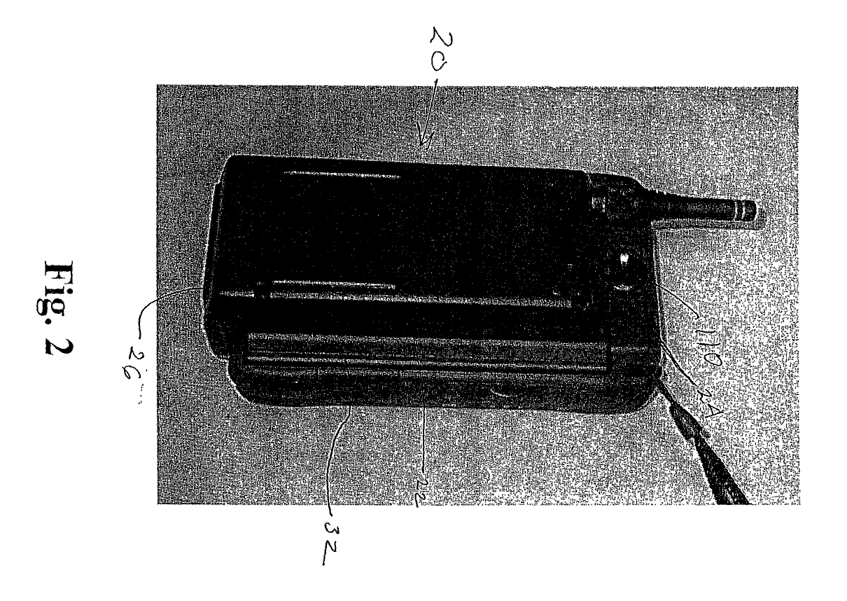

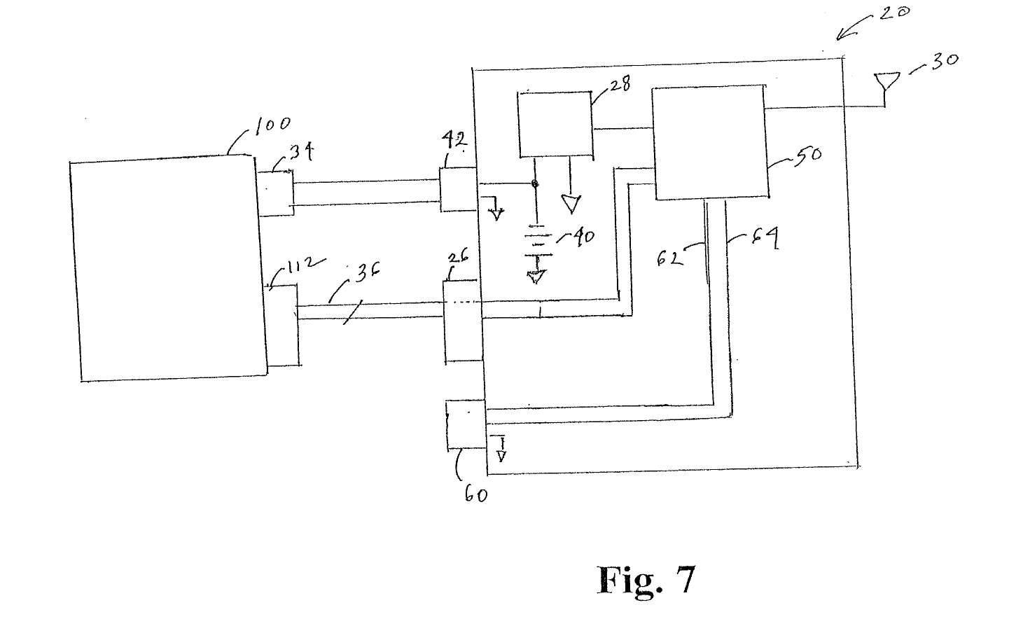

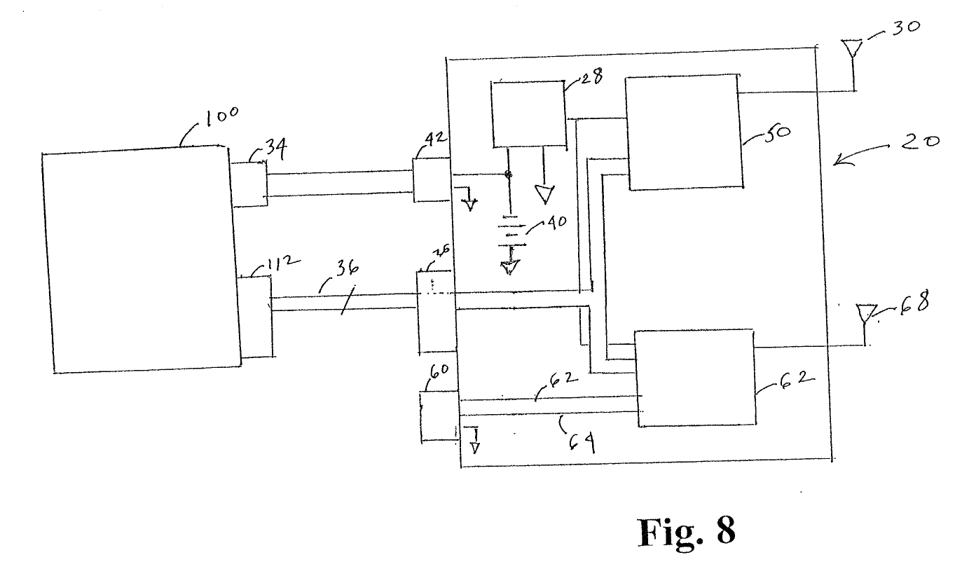

As best seen in FIGS. 1 and 2, when a portable computing device 100 is used with the inventive backpack 20 the battery 102 (FIG. 4) is replaced with backpack 20. Backpack 20 includes battery 40 (FIGS. 7 and 8) for supplying electrical power to the computing device 100, as well as the backpack circuitry as will be discussed in more detail herein below. At the mechanical interface 32 between backpack 20 and computing device 100, the housing 22 of backpack 20 is of substantially the same width and height as battery 102 (FIG. 4) and provides substantially similar mounting features as battery 102 so that attachment of the backpack 20 to the computing device 100 is essentially the same as attachment of the battery 102. When the backpack 20 is attached to computing device 100, flange 24 is captured by latch 110 to secure the backpack 20. Thus, backpack 20 completely replaces battery 102 when attached to computing device 100 making the combination a rugged, aesthetically pleasing, unitary structure. The term “unitary” refers to the nature of the assembled combination and is not meant to in any way limit the removability of backpack 20 from the computing device 100.

Continuing with FIG. 2, backpack 20 includes connector 26 which mates with connector 112 (FIG. 4) on computing device 100. In the preferred embodiment, computing device 100 provides serial data (i.e., RS-232) through connector 26 (FIG. 7) for transmitting data to and receiving data from backpack 20. However, as will be understood by those skilled in the art, there are a variety of techniques for digital communication which could be employed between the backpack 20 and a portable computing device. Preferably, mating of connector 26 with connector 112 occurs automatically with the mounting of backpack 20. In addition, electrical power is communicated to the computing device 100 through contacts 34 (FIG. 4) in precisely the same manner as with battery 102.

While the portable computing device 100 is depicted in the drawings as a hand held computer, it will be understood by those skilled in the art that the term “portable computing device” encompasses a broad range of devices including, by way of example and not notebook computers, PDA'S, printers, scanners, card readers, bar code devices, and the like. Preferably, a portable computing device will include a removable battery. The inventive backpack is for use with any such portable device intended to transmit or receive digital signals.

Referring now to FIG. 7, preferably the battery 40 incorporated in backpack 20 will be lithium polymer type battery or other suitable rechargeable battery. In the preferred embodiment, the voltage which must be supplied to power wireless transceiver 50 is different than the voltage which must be supplied to computing device 100. Thus, backpack 20 includes a voltage converter 28 for boosting the voltage as necessary for operation of the wireless transceiver 50. As will be apparent to those skilled in the art, this eliminates the need for separate batteries for the wireless communication transceiver (as is the case when using a cellular phone attached via a cable). In addition, a single indicator can be used to indicate the level of charge for the entire system.

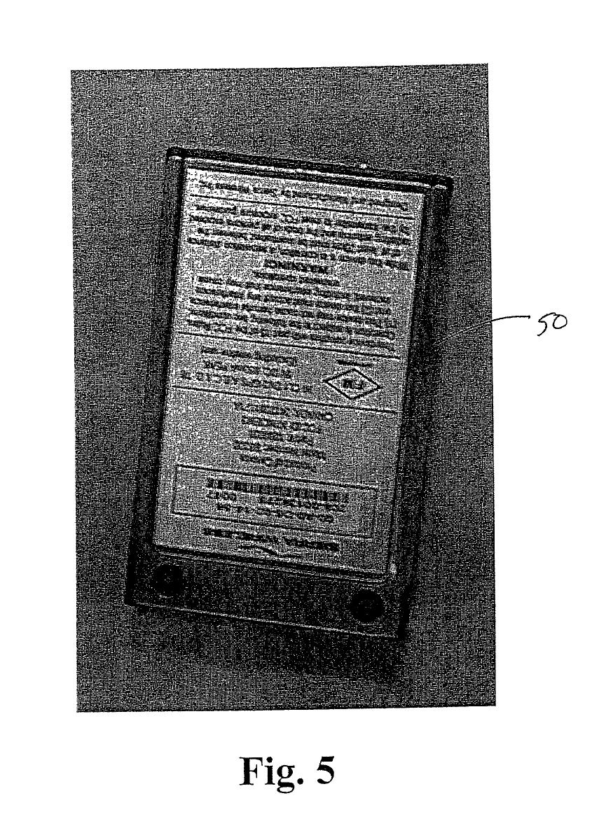

Referring next to FIGS. 5 and 7, transceivers for use with a cellular network are known in the art. In the preferred embodiment, a transceiver 50 (FIG. 5) from Sierra Wireless, Inc. of Richmond, BC was selected. Preferably transceiver 50 provides a command interpreter to separate control information from data sent over a single digital interface, serial bus 36. Control information is sent from the device 100 to backpack 20 in the form of standard AT modem commands. The AT command set is well known in the art as are the steps processed by the transceiver 50 in response to various AT commands.

In one preferred embodiment of backpack 20, the wireless communication transceiver is configured for communication over an existing cellular network. As mentioned hereinbefore, the term “cellular” as used herein is to be interpreted broadly to include any multiple access wireless network, including, but not limited to systems employing frequency division multiple access, time division multiple access, code division multiple access schemes, as well as any similar multi-user scheme. It should be noted, that depending on the particular cellular method employed by the wireless transceiver 50, that digital information may be wirelessly transmitted and received in the form of conventional modem signals or, alternatively, may be sent and received directly in digital form by the transceiver 50.

In addition, the backpack 20 may provide voice communication through connector 60. The transceiver 50 wirelessly transmits audio from input 62 and delivers received audio to output 64 upon direction from the computing device via serial bus 36. If a single wireless transceiver 50 is employed, the user may elect to communicate either digitally to send and receive data at the portable computing device 100, or alternatively, to communicate with voice.

In a second embodiment, as shown in FIG. 8, backpack 20 includes a second wireless transceiver 62. In this instance, transceiver 50 is dedicated to providing data communication for the portable computing device 100 while wireless transceiver 62 is dedicated to providing voice communication through connector 68. Thus, simultaneous transmission and reception of both voice and data are possible. It will be apparent to those skilled in the art that, with multiple wireless transceivers 50 and 62, the backpack may require multiple antennas 30 and 68. Preferably, to reduce interference between the transceivers 50 and 62, antennas 30 and 68 are physically separated by pacing antenna 30 at one end of backpack 20 and antenna 68 at the other end.

Referring once again to FIG. 7, in an alternate preferred embodiment, wireless transceiver 50 is a low power radio transceiver for communication over relatively short distances, typically less than 100 meters, rather than a cellular transceiver. Preferably, transceiver 50 comprises a spread spectrum or frequency hopping transceiver such that several of such systems may operate within the operable range of each other without causing interference among the various systems. Transceivers operating in accordance with the Bluetooth™ standard would provide suitable operability. In addition, the Bluetooth™ standard provides for both voice and data communications with a single transceiver thereby providing a similar level of operability for local use as the cellular radio embodiment provide for wide area use.

As will be apparent to those skilled in the art, backpack 20 could instead be provided with a housing for attachment to a portable peripheral device. For example, backpack 20 could be configured to attach to a portable printer rather than a hand-held computer. In such an embodiment, backpack 20 could be provided with additional circuitry to provide AT commands to the transceiver for initiating a wireless connection to another device. Such circuitry would be within the skill level of one of ordinary skill in the art.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention.

We claim:

1. A wireless communications backpack comprising
a housing for mounting said backpack;
a portable computing device wherein said backpack is mounted in said housing and attached to said portable computing device for digital communication with another computer or peripheral;
a battery suitable for providing voltage to said portable computing device and said backpack; and
a wireless communications device incorporated in said backpack.

2. The wireless communications backpack of claim 1, wherein said housing comprises a flange for mounting said backpack.

3. The wireless communications backpack of claim 1, wherein said wireless communication device is a radio transceiver.

4. The wireless communications backpack of claim 1, wherein said battery is removably attached to said computing device with a plurality of tabs and a flange secured by a latch.

5. The wireless communications backpack of claim 1, wherein said computing device comprises an interface for input and output of data.

6. The wireless communications backpack of claim 1, wherein said portable computing device provides digital wireless communication over a cellular network.
